(19) United States
(12) Patent Application Publication
(10) Pub. No.: US 2006/0283814 A1
(43) Pub. Date: Dec. 21, 2006

(54) Gravitational separator and apparatus for separating floating particulate and volatile liquids from a stormwater stream adaptable for inline usage

(76) Inventors: J. Kelly Williamson, Chattanooga, TN (US); Eric Rominger, Chattanooga, TN (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 11/413,379

(22) Filed: Apr. 29, 2006

Related U.S. Application Data
(60) Provisional application No. 60/676,111, filed on Apr. 29, 2005.

(51) Int. Cl. B01D 21/26

(52) U.S. Cl. 210/787

(57) ABSTRACT

A hydrodynamic gravitational separator has an input channel positioned to tangentially direct storm water into collection and treatment cavity while remaining operable in high flow conditions to divert excess storm water directly through to an outlet pipe.

The present application claims priority to the Apr. 29, 2005 filing date of U.S. provisional patent application Ser. No. 60/676,111, which is incorporated herein.

### FIELD OF THE INVENTION

The present invention relates generally to the treatment of storm water and provides for a gravitational system to remove non-floating particulate and a separator to isolate floating particles as well as liquids such as oil and gasoline residue which may be contained in storm water.

### BACKGROUND OF THE INVENTION

It is known that residue from oil and gasoline spills at service stations, parking lots, and similar sites commonly remains at the site of the spill until washed away by water from rainfall or hose cleaning operation. The residue is often washed to a drain where it is likely to be carried to and mixed with the water supply from which drinkable water is ultimately taken. The protection of ground water and natural bodies of water requires systems for diverting or treating the water that contacts parking lots, roadways, and other contaminated structures. Similar problems and environmental concerns arise at alternative sites generating waste water, and these various sources of contaminated water will generally be referred to as storm water for the purposes of this application.

The storm water may contain a variety of contaminants, including floating particulate such as plastics, or volatile fluids such as gas and oil residue that will tend to float on stationary water; non-floating particulate such as sand, silt and pebbles; and entrained contaminants such as fertilizer or other various organic or inorganic contaminants that may have leeched from upstream sites.

In order to effectively treat storm water, it is often desirable to have multiple separation stages and, most typically, a preliminary mechanical separation phase that removes the heavier than water particulates and lighter than water contaminants, followed by a filtration phase which is designed to remove entrained contaminants or contaminants that could not be gravitationally separated. Because the rate of storm water passing through a treatment system is generally subject to wide variations depending upon rainfall, any treatment system must be designed to accommodate a wide range of flow rates. In some instances, this is handled by diversion upstream from the treatment system that simply diverts any storm water in excess of the capabilities of the treatment system so that excess quantities of water bypass the treatment system. Such wholesale diversion from the treatment system is not desirable, both because of the perception that untreated storm water is being directed into rivers, lakes, or ground water and because diversion requires additional drainage piping and land area. In many instances, the use of gravitational separators and filters for water treatment is desirable in lieu of holding ponds or other treatment alternatives due to space restrictions, so the space required for diversion may be costly or unavailable.

Rapidly flowing storm water may also sweep up sizeable articles of debris and it is desirable for a treatment device to be able to handle such articles as may enter the treatment device from the drain system without clogging. Clogging can result not only in untreated storm water, but may back up the drainage system and cause serious flooding damages.

### SUMMARY OF THE INVENTION

Therefore, it is an object of the present invention to provide a new and improved gravitational separator that accommodates both low storm water flow rates and high storm water flow rates in a fashion that does not require diversion.

It is another object of the invention to provide a separator which is easily serviceable and not subject to clogging when utilized for storm water treatment.

It is yet a further object of the invention to provide such a gravitational separator which is easily constructed and installed and easily modified in dimension to accommodate the character of contaminants in a given storm water drainage location.

These and other objectives are achieved with the present gravitational separator which is positionable in a drainage system having an upstream pipe portion through which storm water enters the separator and a downstream pipe portion through which drain water exits the separator. The separator is preferably comprised of a generally cylindrical cavity with inlets and outlets for storm water and two baffles. An opening is provided at the top of the separator so that contaminants collected within may be periodically removed, typically through the use of a contaminant removal vehicle having a vacuum hose.

### BRIEF DESCRIPTION OF THE DRAWINGS

FIG. 1 is a top plan view of a separator constructed according to the invention.

FIG. 2a is a side plan view of the separator constructed according to the invention.

FIG. 2b is a side plan view of the riser of the separator of FIG. 2a.

FIG. 3 is a sectional high angle back view of a separator of the present invention in a low flow rate status.

FIG. 4 is a sectional plan view of the separator of FIG. 3, rotated about 60 degrees beyond that back view.

FIG. 5 is a phantom side plan view of a separator according to the invention illustrating water flow with directional arrows.

### DETAILED DESCRIPTION OF THE ILLUSTRATED EMBODIMENTS

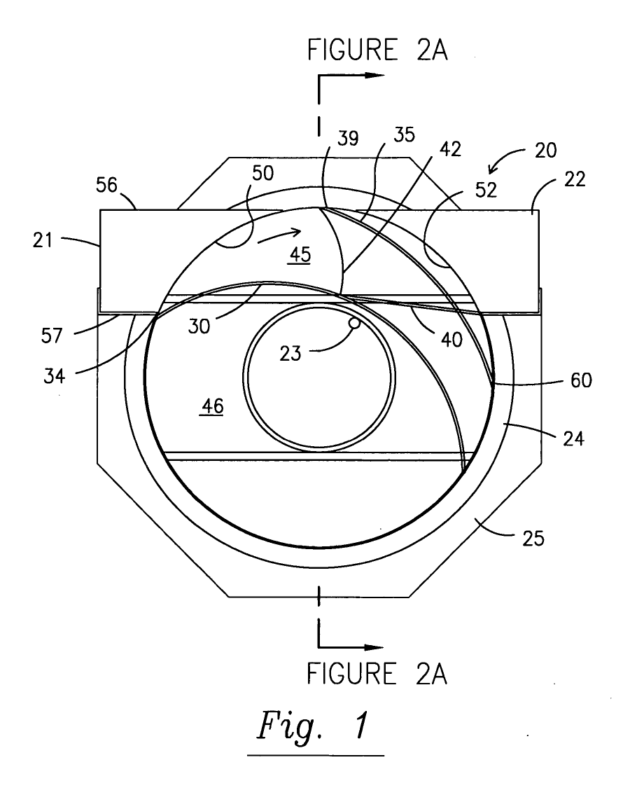

Turning first to FIG. 1, there is an illustrated embodiment of a hydrodynamic gravitational separator 20 according to the present invention. The depicted separator 20 is designed for use in the treatment of storm water where storm water is introduced to the separator 20 through inlet pipe 21 and treated storm water exits from the separator through outlet pipe 22. Because of the unique design of the separator an upstream weir to divert high flow condition water is not necessary. The interior chamber 29 of the separator 20 is defined by cylindrical inner wall 24, floor 25, and top 26. Preferably, the top 26 has a central opening to which is connected a riser 27 and the riser is fitted with a cover 28.

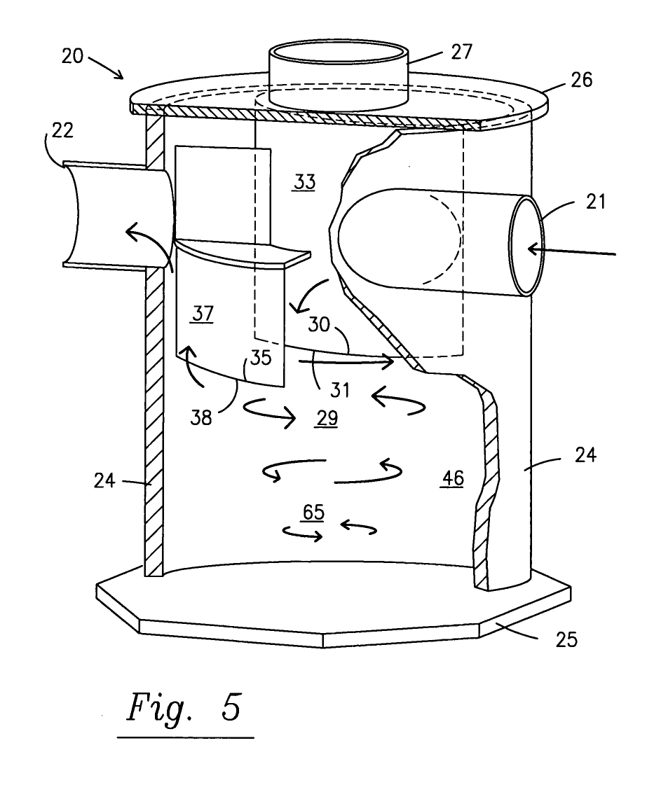

As most clearly shown in FIGS. 1 and 5, in operation, water from inlet pipe 21 enters chamber 29 through inlet 50 which is positioned between leading edges 34, 39 of interior baffle 30 and exterior baffle 35. Interior baffle 30 has an upper portion 61 fastened to top 26 of the separator and a lower edge 31 and an arcuate panel 33 between. The exterior baffle has an upper connecting and spacing flange 36 which is connected to the side wall 24 of separator 20 and which supports arcuate panel 37 extending downward to bottom edge 38. At a low flow rate storm water from inlet pipe 21 enters the flow control area 45 between interior 30 and exterior 35 baffles and proceeds into a treatment flow channel beneath the bypass baffle 42 or covering portion of flange 36 into the rotational circulation section 46 or vortex of flow chamber 29. The leading 34,39 and trailing 60 edges of arcuate panels 33, 37 are substantially flush with inner wall 24.

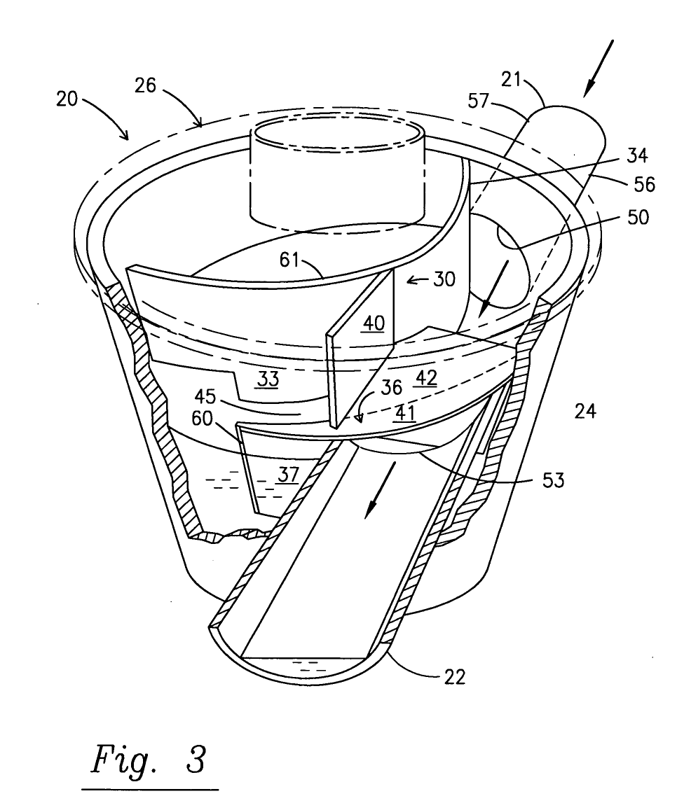

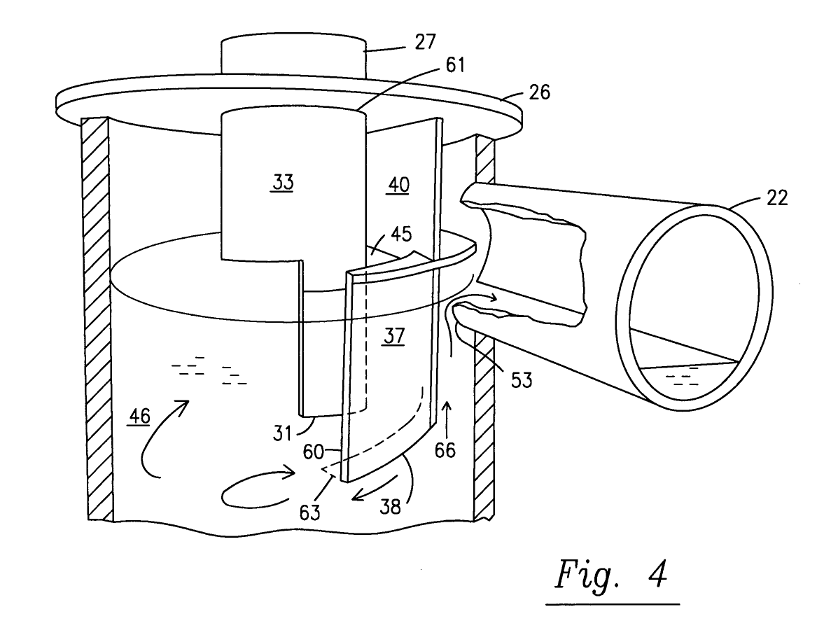

The connecting flange 36 extends not only outward from chamber wall 24 to support the arcuate plate 37 of the exterior baffle, but also extends across the space between interior and exterior baffles 30, 35 at an approximate height of the mid-point of both the inlet pipe 21 and outlet pipe 22. The exterior baffle 35 does not extend above the flange 36. In this fashion it may be seen that the connecting and spacing flange 36 has both a gap spacing portion 41 (shown in FIG. 3) which spaces the exterior baffle from interior wall 24 and a cover portion 42 which forms a part of a three-sided channel 47 defined by cover 42, interior arcuate wall 33, and exterior baffle arcuate wall 37 through which incoming storm water proceeds to the central circulation section 46 for treatment. The spacing between interior arcuate wall 33, and exterior baffle arcuate wall 37 gradually narrows from about the width of the inlet pipe 21 at their front edges, to approximately 75% of that width at their trailing edges. The narrowed spacing creates a pinch zone that encourages water flow in a downward direction. To minimize any tendency for incoming water to immediately proceed under edge 38 and out, the narrowing of the pinch zone can be lessened, and an inward facing flange 63 or floor added to the exterior baffle. Once in the central circulation portion 46, storm water circulates generally around the interior circular wall 24 but is constrained by interior baffle 30 against reaching the inlet 50 area, or the outlet 52 area. As shown in FIG. 4, when the water level in the separator 20 rises above the lower edge 53 of outlet pipe 22, downward pressure is exerted on water in the chamber so that it flows under lower edge 38 of exterior baffle 35 upward through exit zone 66 and over lower edge 53 of outlet pipe 22 and onward through the drainage and treatment system.

When the water is in the circulation area 46 of the flow chamber 29 a relative calm exists in the central portion of the chamber with low water flow velocities. The low velocity allows time for gravitational and hydrodynamic drag forces to act on the contaminants, encouraging solids to drop out of the flow and migrate to the bottom center of the chamber where velocities are lowest, creating a sediment retention area 65 at the bottom of the chamber. Simultaneously, floatable contaminants, and especially hydrocarbons such as gasoline and oil residues, will float to the top of the water in the central area, from which position it cannot escape under the bottom edge 38 of the exterior baffle 35.

This generally describes the operation of the separator 20 in moderate storm water flow conditions and in first flow conditions. First flow conditions are the beginning point of a drainage event, and these initial first flow storm water fluids typically carry the heaviest load of contaminants for treatment. In the event of a high flow event, the separator 20 may be operating at near full capacity with approximately a half full inlet pipe 21 of storm water continually entering separator 20. As the flow increases beyond that point, the storm water will begin to flow not only through channel 47 into the treatment and circulation area 46, but will also flow directly over bypass baffle that is formed by the top surface of cover 42 and into outlet pipe 22 without treatment. The combination of interior baffle 30, high flow weir 40, and cover 42 and side wall 24 effectively directs all of this excess high flow water directly into outlet pipe 22 without treatment. Thus the leading edge of cover 42 operates as a bypass baffle in a bypass zone such that water passing beneath the cover 42 goes into the treatment channel, and water passing above the cover 42 goes into the bypass channel. Fortunately, since these high flow conditions generally occur only after the contaminant laden first flow storm water has been treated and because the most substantial particulate debris will be gravitationally directed into channel 47 for treatment, the deleterious effects from this high flow treatment bypass condition are relatively minimal.

Although the walls 24, bottom 25 and top 26 of the separator 20 may be fabricated of a number of materials such as steel, resin composites, or concrete, a preferred material is durable high density polyethylene (HDPE) which provides for long useful life and also results in a lightweight separator device so that the separator can be substantially pre-fabricated and shipped to a job site and off loaded without special lifting equipment to accommodate easy onsite handling and installation.

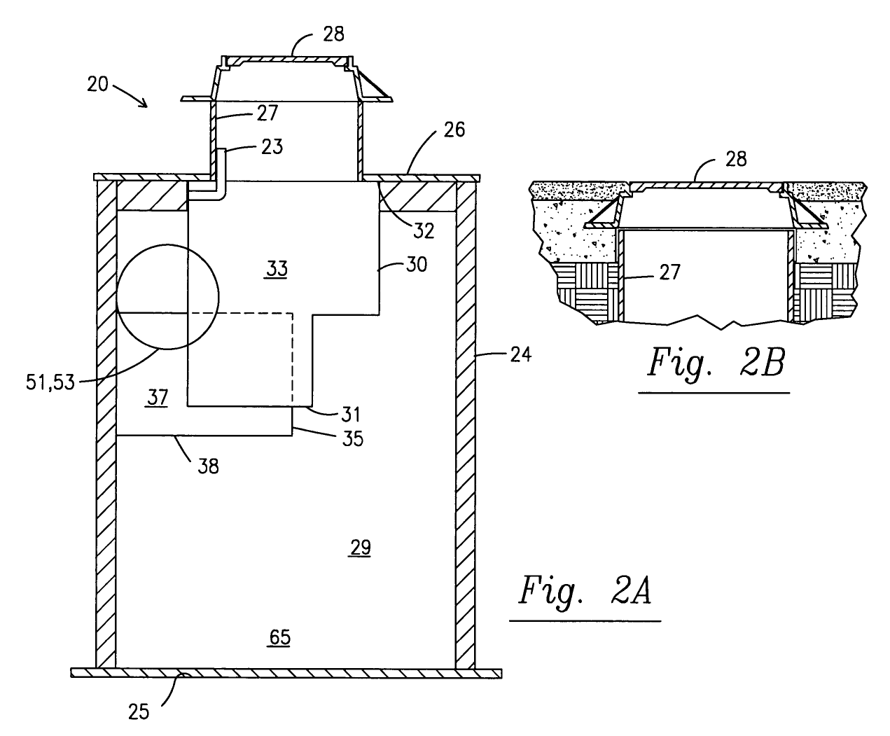

At the top 26, a central riser wall 27 may be affixed according to the depth at which the separator 20 is buried. This riser may be cut from appropriately sized HDPE pipe and fused to the top 26 by the installation contractor to match finished site grade. Exemplary dimensions of the separator shown in FIGS. 1 and 2 with a six foot diameter defined by the exterior wall 24 could be about eith to nine feet of overall height, the exterior baffle having a height of about 24 to 30 inches, and extending downward from the midpoint of the inlet pipe 21, which is positioned at about two-thirds the overall height of the chamber. The interior baffle extends downward by about 48 to 55 inches to a depth about six inches higher than the bottom edge of the exterior baffle 35.

The direction of water flow from inlet pipe 21 should be generally tangential in relation to the wall 24 of separator 20. Specifically, the outermost wall 56 of inlet pipe 21 should form a tangent line with respect to cylindrical wall 24 or be just interior of such a line. The inner wall 57 of inlet pipe 21 should be nearly tangential with the arcuate plate 33 of interior baffle 30. Thus, upon the very entry of storm water into separator 20, the storm water begins to be diverted by arcuate walls 33, 37 of baffles 30, 35, and then by cylindrical wall 24 into a circular flow. The combination of gravitational and hydrodynamic drag forces within the central circulation portion 46 within the lower portion of chamber 29 encourages solids to drop out of the flow and migrate to the center of the chamber where velocities are lowest. The floatable pollutants rise to the top of the central circulation portion 46 and cannot escape beneath the bottoms 31, 38 of the interior or exterior baffles 30, 35. The vent 23 extends up the riser 27 to expose the back side of interior baffle 30 to atmospheric conditions and thereby prevent any syphon from forming at the bottom of the baffle.

While the separator 20 may be operated in an offline configuration, the interior diversion of high water flow directly through to outlet pipe 22 allows the separator to be used in a fully online configuration. The separator shown in FIGS. 1 and 2 is dimensioned to have a six foot inner swirl diameter, to be connected to inlet and outlet pipes having a diameter of between about 22 and 30 inches, provides the capability to treat approximately 6.3 cubic feet per second of storm water, can store up to about 390 gallons of oil and dirt debris, and about 65 cubic feet of sediment. By increasing the separator 20 to a ten foot inner swirl diameter, inlet and outlet pipes up to about 54 inches in diameter may be accommodated, and 17.5 cubic feet of storm water treated per second. Oil debris storage capacity increases to over 1100 gallons and the sediment storage capacity increases to approximately 180 cubic feet. With such larger ten and twelve foot inner swirl diameter configurations, it becomes desirable to have at least a second riser and cover to facilitate the maintenance of removing oil debris and sediment that has been captured.

Removal efficiencies are tested in stormwater treatment using OK-110 sand, available from U.S. Silica, comprised of round sand principally between about 75 and 125 microns in diameter. The online separator of the present invention can operate at an 80% removal efficiency at high flow rates with respect to the larger grains of OK-110 sand. In bypass flow rates, some efficiency is sacrificed. In addition, with respect to very small particle sizes on the order of less than about 75 microns, removal efficiencies are diminished as these particles are not only difficult to settle in a dynamic system, but also tend to become re-entrained in the water flow after initially settling.

Although preferred embodiments of the present invention have been disclosed in detail herein, it will be understood that various substitutions and modifications may be made to the disclosed embodiment described herein without departing from the scope and spirit of the present invention as recited in the appended claims.

I claim:

1. A water treatment apparatus comprising:
(a) a chamber defined by an annular wall, a floor and a top;
(b) an inlet by which water enters the chamber through the annular wall;
(c) a bypass zone where water entering the chamber is directed to a treatment channel and a bypass channel;
(d) a vortex where water passing through the treatment channel is circulated;
(e) an exit zone through which treated water passes; and
(f) an outlet by which water from the exit zone and the bypass channel leaves the chamber through the annular wall.

2. The water treatment apparatus of claim 1 wherein the bypass zone comprises a bypass baffle directing water passing over the bypass baffle to the bypass channel and water passing under the bypass baffle to the treatment channel.

3. The water treatment apparatus of claim 2 wherein the bypass channel is defined by a top surface of the bypass baffle, the annular wall, and a vertically oriented interior baffle.

4. The water treatment apparatus of claim 3 wherein the bypass channel is further defined by a weir on the top surface of the bypass baffle extending between the vertically oriented interior baffle and the annular wall.

5. The water treatment apparatus of claim 1 wherein an inlet pipe directs water through the inlet in a direction nearly tangential to the annular wall.

6. The water treatment apparatus of claim 2 wherein the treatment channel is defined by a bottom surface of the bypass baffle, an arcuate interior baffle and an arcuate exterior baffle.

7. The water treatment apparatus of claim 6 wherein the space between the interior and exterior baffles narrows to form a pinch zone.

8. The water treatment apparatus of claim 1 wherein the exit zone is defined by a vertically oriented exterior baffle and the annular wall.

9. The water treatment apparatus of claim 1 wherein sediment is retained in the bottom of the chamber.

10. The water treatment apparatus of claim 1 wherein a top section of the vortex is defined by the annular wall and a vertically oriented interior baffle.

11. The water treatment apparatus of claim 11 wherein floatable contaminants are retained in the chamber at the top of the vortex.

12. The water treatment apparatus of claim 5 wherein an outermost wall of the inlet pipe is nearly tangential with the annular wall and in innermost wall of the inlet pipe is nearly tangential with a vertically oriented interior baffle.

13. The water treatment apparatus of claim 2 wherein the bypass baffle extends horizontally inward from the annular wall at about the midpoint of the inlet.

14. The water treatment apparatus of claim 1 wherein a covered riser extends upward from the top.

15. A method of treating water with a water treatment apparatus comprising the steps of:
(a) introducing the water through an inlet into a chamber of the apparatus defined by an annular wall;
(b) utilizing a bypass baffle in the chamber to direct the water into a treatment channel and a bypass channel;
(c) directing the water from the treatment channel into a vortex defined by an interior vertical baffle and the annular wall for circulation;
(d) hydrodynamically separating both sediment and floatable contaminants from the water in the vortex;
(e) causing water from the vortex to flow under an exterior vertical baffle to an exit zone;
(f) directing water from the exit zone through an outlet out of the chamber.

16. The method of treating water with a water treatment apparatus in claim 15 further comprising the step of directing the water to the inlet with an inlet pipe in a direction nearly tangential with the annular wall.

17. The method of treating water with a water treatment apparatus in claim 15 wherein the width of the treatment channel narrows to form a pinch zone.

18. The method of treating water with a water treatment apparatus in claim 15 further comprising the step of directing water from the bypass channel through an outlet out of the chamber.

19. A hydrodynamic gravitational separator for use in treating contaminated water comprising:
(a) a chamber defined by an annular wall, a floor and a top;
(b) an inlet pipe connected to an inlet in the annular wall and configured so that an outside edge of the pipe is aligned nearly tangentially with the annular wall;
(c) a flange extending inwardly from the annular wall and positioned with a leading edge proximate the inlet and extending to contact an interior arcuate vertical baffle, and with a trailing edge extending to an outlet in the annular wall;
(d) an exterior arcuate vertical baffle extending downward from the flange, where the exterior baffle has leading and trailing edges that are mounted flush with the annular wall;
(e) the interior arcuate vertical baffle having a leading edge connected to the annular wall near an inside edge of the inlet pipe;
(f) an outlet pipe connected to the outlet in the annular wall, positioned so that the trailing edge of the flange is near the vertical midpoint of the outlet pipe;
(g) a weir on a top surface of the flange extending from the interior arcuate vertical baffle to the annular wall adjacent an inside edge of the outlet pipe.

20. The hydrodynamic gravitational separator of claim 19 wherein a bottom edge of the exterior baffle sits lower in the chamber than a bottom edge of the interior baffle.
